(19) United States
(12) Patent Application Publication
(10) Pub. No.: US 2006/0242591 A1
(43) Pub. Date: Oct. 26, 2006

(54) File dialog user interfaces and creation of same

(75) Inventors: Cornelis Van Dok, Bellevue, WA (US); David G. DeVorchik, Seattle, WA (US); Philip P. Fortier, Seattle, WA (US); Lyon Wong, Issaquah, WA (US); Timothy P. McKee, Seattle, WA (US); Patrice L. Miner, Kirkland, WA (US)

Correspondence Address: BANNER & WITCOFF LTD.,;ATTORNEYS FOR CLIENT NOS. 003797 & 013797, 1001 G STREET , N.W., SUITE 1100, WASHINGTON, DC, 20001-4597, US

(73) Assignee: Microsoft Corporation, Redmond, WA (US)

(21) Appl. No.: 11/111,990

(22) Filed: Apr. 22, 2005

(51) Int. Cl. G06F 9/00

(52) U.S. Cl. 715/762

(57) ABSTRACT

An OS generates a file dialog in response to a request from an application program. The file dialog has a format with a dedicated extensibility region. Multiple user interface controls from a predefined collection of UI control types can be placed within the extensibility region. An application requesting display of a file dialog requests one or more controls of the types in the predefined collection. The OS then places the requested controls in the extensibility region of the displayed dialog. The application need not provide data explicitly indicating the positions within the dialog of the requested controls.

### FIELD OF THE INVENTION

The invention generally relates to computer user interfaces (UIs) and to creation of user interfaces. More specifically, embodiments of this invention relate to dialog UIs for accessing data files, and to programming interfaces allowing software developers to more conveniently create such dialogs.

### BACKGROUND OF THE INVENTION

The use of dialogs as part of a computer's graphical user interface (GUI) is known. As used herein, a “dialog” includes a window or other portion of a graphical computer display which appears in order to communicate information from a computer program and/or obtain information from the user. Some of the most frequently-used types of dialogs can be categorized as “file” dialogs. In general, file dialogs allow a user to specify one or more files that are to be processed in some manner by a computer. Familiar examples include dialogs for opening a file and dialogs for saving a file. Other examples include dialogs for inserting file attachments into an email, dialogs for importing files into or exporting files from a database, etc.

The specific content and layout of file dialogs can vary widely. The requirements of an application or other software program instantiating a file dialog have a large impact on that file dialog's content and format. However, the preferences and objectives of the software developer are also of major importance. Many software developers wish to customize file dialogs for their programs. The reasons for this can vary. In some cases, for example, a developer may wish to add functionality that is not available in a standardized file dialog. For example, the developer may wish to enable a user to place a password on a file or make a file open in read-only mode by default. As another example, a graphics application may have options dealing with things (e.g., color depth) that would not be included in a standardized file dialog.

In many computing environments, a file dialog is generated by an operating system (OS) in response to a function call or other request from an application program. Unfortunately, such an arrangement can pose several challenges in connection with customizing a file dialog. In order to be commercially viable, an OS typically offers a finite number of standardized file dialogs and programming interfaces allowing some degree of modifying a standardized dialog. However, known OSs typically do not provide enough modification choices to satisfy the file dialog customization desires of many application developers. As a result, many developers design their own file dialogs by writing extensive code to generate desired dialog elements within a standard dialog.

This can be described more clearly using a simplified example. Suppose a hypothetical OS includes a function “FileDialog(argument_a, argument_b, . . . ).” By calling FileDialog and specifying values for the various arguments, an application causes the OS to display a standardized file dialog as a new window on a computer display. The function arguments might include things such as a directory location in which to search for files to open, etc. However, the customization options available using the FileDialog function may not be enough to satisfy the needs of a hypothetical application developer. In such cases, the developer may be required to write detailed code which creates the desired customization as a child window of a standardized file dialog.

This scenario can create a number of problems. Much more effort is required by the application developer creating a customized file dialog. This can increase the cost of creating new software and increase code complexity. This scenario is also problematic for the OS developer. If numerous applications create customized file dialogs in this manner, the OS developer may have difficulty learning about all of those customizations. This can then impair the OS developer's ability to make future OS upgrades. If the OS is changed in a way that is incompatible with some customized dialogs, the OS may no longer support the software applications which rely on those dialogs.

Consistency across dialogs generated by various computer programs is also an area of concern. Although application developers should be allowed a great deal of creativity, some commonality is also desirable. If all file dialogs have a similar design, users become accustomed to a general dialog format. Users then know where to look in each dialog for important information and can thereby respond more quickly. If many files dialogs have vastly different layouts and are otherwise not consistent in how they communicate information and seek user input, users may be required to spend more time studying each dialog.

For these and other reasons, there remains a need for methods and systems to assist software developers in creating better file dialog user interfaces.

### SUMMARY OF THE INVENTION

Embodiments of the invention address these and other challenges. In at least some embodiments, an OS generates a file dialog having a dedicated extensibility region for inclusion of one or more user interface (UI) controls. The controls which can be included in an extensibility region are selectable from a predefined collection of UI control types. When an application requests the OS to display a file dialog, the application can request inclusion of one or more controls of the types in the predefined collection. The OS then places the requested controls in the extensibility region of the displayed dialog. The application need not provide data explicitly indicating the positions within the dialog of the identified controls. The application may also request that the controls be placed in groups and/or that separators be included between groups.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1A is a block diagram of an example of a computing system environment in which embodiments of the invention may be implemented.

FIGS. 1B through 1M show programming interfaces, in a general-purpose computer environment, with which one or more embodiments of the present invention may be implemented.

FIGS. 2 and 3 are examples of an “Open File” dialog according to at least some embodiments of the invention.

FIGS. 4 and 5 are examples of a “Save File” dialog according to at least some embodiments of the invention.

FIGS. 6-10B are examples of additional user interface (UI) controls which may be added to a file dialog according to at least some embodiments of the invention.

FIGS. 11 and 12 show automatic arrangement of UI controls according to at least some embodiments of the invention.

FIGS. 13 and 14 are block diagrams schematically illustrating differences between the manner in which an application requests generation of a file dialog according to embodiments of the invention and the manner in which a file dialog is requested in the prior art.

### DETAILED DESCRIPTION OF THE PREFERRED EMBODIMENTS

The following detailed description is divided into three parts. Part I describes an example of a computer system environment in which embodiments of the invention may be implemented. Part II describes examples of at least some programming interfaces which can be used to implement embodiments of the invention. Part III describes embodiments of enhanced file dialog user interfaces (UIs) and methods for implementing such dialogs.

I. Example Computing System Environment

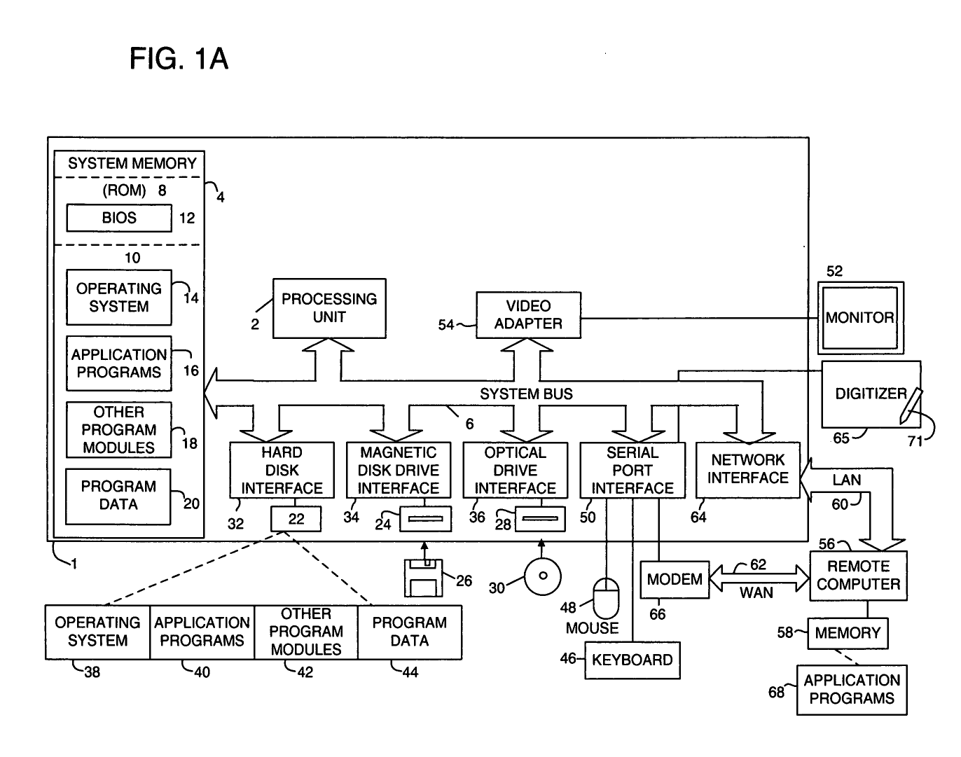

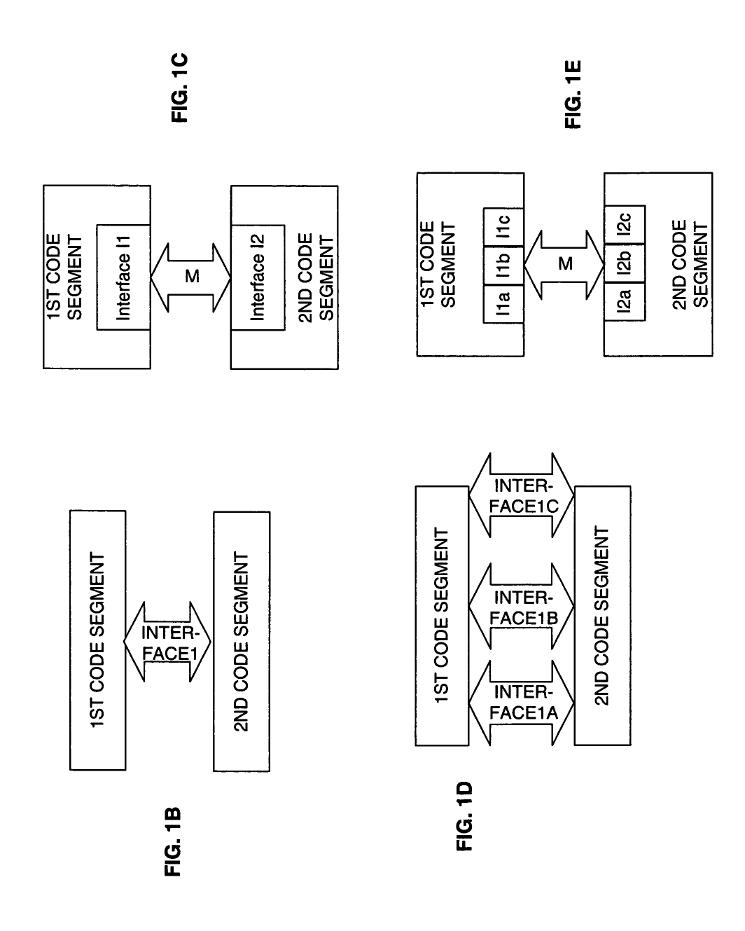

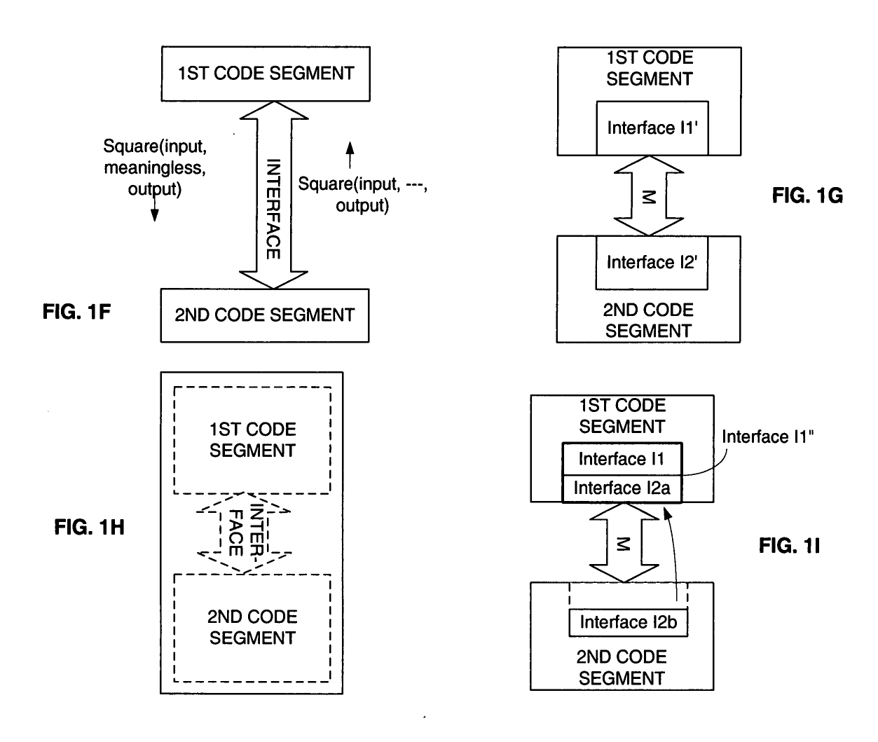

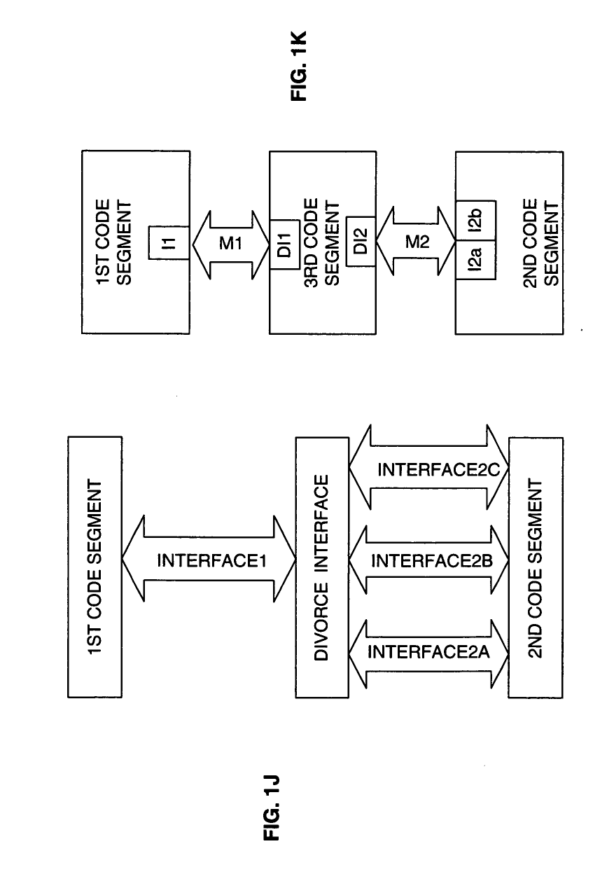

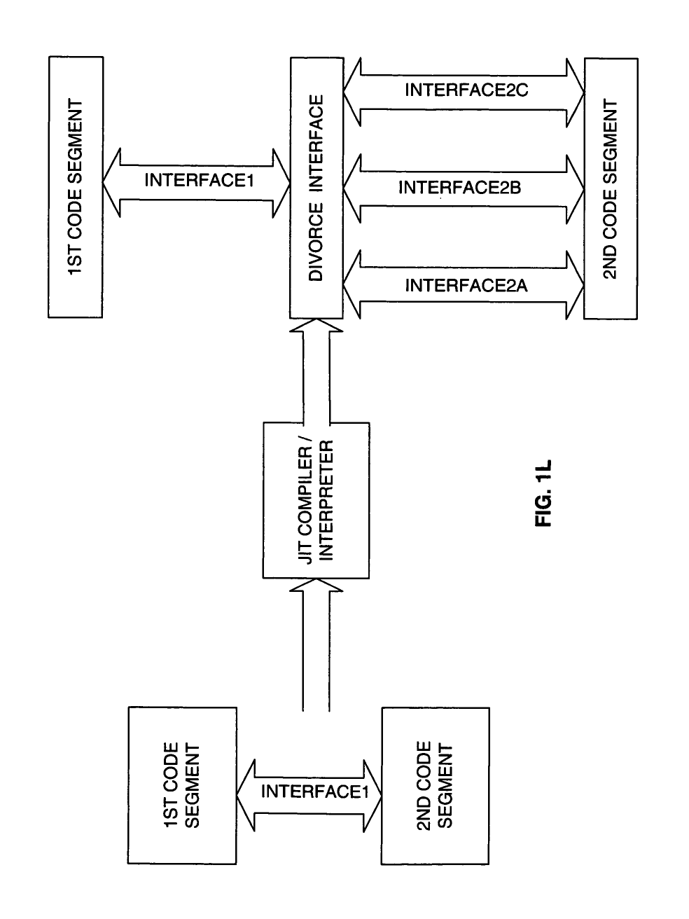

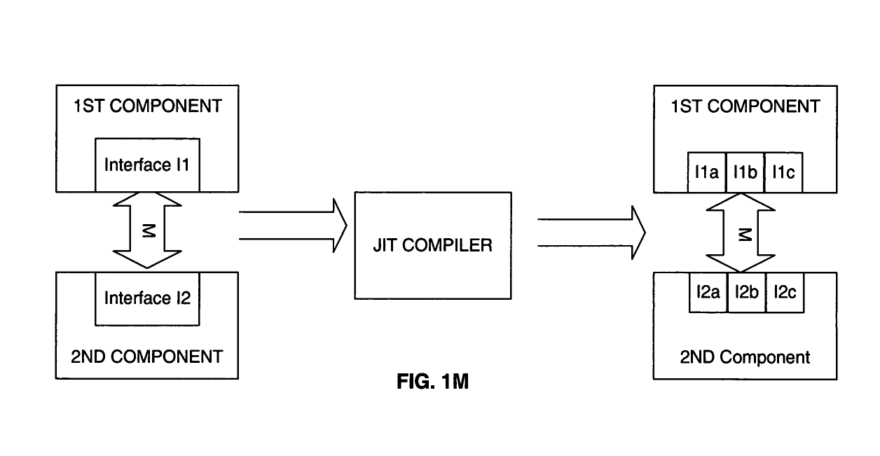

FIG. 1A illustrates an example of a suitable computing system environment in which the invention may be implemented. The computing system environment is only one example of a suitable computing environment and is not intended to suggest any limitation as to the scope of use or functionality of the invention. Neither should the computing environment of FIG. 1A be interpreted as having any dependency or requirement relating to any one or combination of components illustrated in the exemplary computing environment. Embodiments of the invention will also be described using as examples data structures found in various versions of the WINDOWS operating system. However, the invention is not limited to implementation in connection with a specific operating system.

The invention is operational with numerous other general purpose or special purpose computing system environments or configurations. Examples of well known computing systems, environments and/or configurations that may be suitable for use with the invention include, but are not limited to, personal computers, hand-held or laptop devices, multiprocessor systems, microprocessor-based systems, minicomputers, and the like. The invention is described in the general context of computer-executable instructions, such as program modules, being executed by a computer. Generally, program modules include routines, objects, components, data structures, etc. that perform particular tasks or implement particular abstract data types.

With reference to FIG. 1A, an exemplary system for implementing the invention includes a general purpose computing device in the form of a computer 1. Hardware components of computer 1 may include, but are not limited to, processing unit 2, system memory 4 and system bus 6 that couples various system components (including system memory 4) to processing unit 2. System bus 6 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus and Peripheral Component Interconnect (PCI) bus also known as Mezzanine bus.

Computer 1 typically includes a variety of computer readable media. Computer readable media can be any available media that can be accessed by computer 1 and includes both volatile and nonvolatile media, removable and non-removable media. By way of example, and not limitation, computer readable media may include computer storage media and communication media. Computer storage media includes volatile and nonvolatile, and removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 1. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

System memory 4 includes computer storage media in the form of volatile and/or nonvolatile memory such as read only memory (ROM) 8 and random access memory (RAM) 10. Basic input/output system 12 (BIOS), containing the basic routines that help to transfer information between elements within computer 1, such as during start-up, is typically stored in ROM 8. RAM 10 typically contains data and/or program modules that are immediately accessible to and/or presently being operated on by processing unit 2. By way of example, and not limitation, FIG. 1A illustrates operating system (OS) 14, application programs 16, other program modules 18 and program data 20.

Computer 1 may also include other removable/non-removable, volatile/nonvolatile computer storage media. By way of example only, FIG. 1A illustrates hard disk drive 22 that reads from or writes to non-removable, nonvolatile magnetic media, magnetic disk drive 24 that reads from or writes to removable, nonvolatile magnetic disk 26 and optical disk drive 28 that reads from or writes to removable, nonvolatile optical disk 30 such as a CD ROM, CDRW, DVD or other optical media. Other removable/non-removable, volatile/nonvolatile computer storage media that can be used in the exemplary operating environment include, but are not limited to, magnetic tape cassettes, flash memory cards, digital video tape, solid state RAM, solid state ROM, and the like. Hard disk drive 22 is typically connected to system bus 6 through a non-removable memory interface such as interface 32, and magnetic disk drive 24 and optical disk drive 28 are typically connected to system bus 6 by a removable memory interface, such as interfaces 34 and 36.

The drives and their associated computer storage media, discussed above and illustrated in FIG. 1A, provide storage of computer readable instructions, data structures, program modules and other data for computer 1. In FIG. 1A, for example, hard disk drive 22 is illustrated as storing OS 38, application programs 40, other program modules 42 and program data 44. Note that these components can either be the same as or different from OS 14, application programs 16, other program modules 18 and program data 20. OS 38, application programs 40, other program modules 42 and program data 44 are given different numbers here to illustrate that, at a minimum, they are different copies. A user may enter commands and information into computer 1 through input devices such as keyboard 46, pointing device 48 (shown as a mouse, but which could be a trackball or touch pad) and stylus 71 (shown in conjunction with digitizer 65). Other input devices (not shown) may include a microphone, joystick, game pad, satellite dish, scanner, or the like. These and other input devices are often connected to processing unit 2 through user input interface 50 that is coupled to the system bus. Although mouse 48, keyboard 46, digitizer 65 and modem 66 are shown in FIG. 1A as connected to computer 1 through a serial port, these and other devices may be connected to computer 1 through other ports (e.g., a parallel port, PS/2 port, game port or a universal serial bus (USB) port) and related interfaces and structures. Monitor 52 or other type of display device is also connected to system bus 6 via an interface, such as video interface 54. In addition to the monitor, computers may also include other peripheral output devices such as speakers (not shown) and a printer (not shown), which may be connected through an output peripheral interface (not shown).

Computer 1 may operate in a networked environment using logical connections to one or more remote computers, such as remote computer 56. Remote computer 56 may be a personal computer, a server, a router, a network PC, a peer device or other common network node, and typically includes many or all of the elements described above relative to computer 1, although only memory storage device 58 has been illustrated in FIG. 1A. The logical connections depicted in FIG. 1A include local area network (LAN) 60 and wide area network (WAN) 62, but may also include other networks. Such networking environments are commonplace in offices, enterprise-wide computer networks, intranets and the Internet.

When used in a LAN networking environment, computer 1 is connected to LAN 60 through network interface or adapter 64. When used in a WAN networking environment, computer 1 may include modem 66 or other means for establishing communications over WAN 62, such as the Internet. Computer 1 may also access WAN 62 and/or the Internet via network interface 64. Modem 66, which may be internal or external, may be connected to system bus 6 via user input interface 50 or other appropriate mechanism. In a networked environment, program modules depicted relative to computer 1, or portions thereof, may be stored in a remote memory storage device. By way of example, and not limitation, FIG. 1A illustrates remote application programs 68 as residing on memory device 58. It will be appreciated that the network connections shown are exemplary and other means of establishing a communications link between computers may be used.

II. Example Programming Interfaces

A programming interface (or more simply, interface) may be viewed as any mechanism, process or protocol for enabling one or more segment(s) of code to communicate with or access the functionality provided by one or more other segment(s) of code. Alternatively, a programming interface may be viewed as one or more mechanism(s), method(s), function call(s), module(s), object(s), etc. of a component of a system capable of communicative coupling to one or more mechanism(s), method(s), function call(s), module(s), etc. of other component(s). The term “segment of code” in the preceding sentence is intended to include one or more instructions or lines of code, and includes, e.g., code modules, objects, subroutines, functions, and so on, regardless of the terminology applied or whether the code segments are separately compiled, regardless of whether the code segments are provided as source, intermediate, or object code, regardless of whether the code segments are utilized in a runtime system or process, regardless of whether they are located on the same or different machines or distributed across multiple machines, and regardless of whether the functionality represented by the segments of code are implemented wholly in software, wholly in hardware, or a combination of hardware and software. By way of example, and not limitation, terms such as application programming interface (API), entry point, method, function, subroutine, remote procedure call, and component object model (COM) interface are encompassed within the definition of programming interface.

A programming interface may be viewed generically as shown in FIG. 1B or FIG. 1C. FIG. 1B illustrates an interface Interface1 as a conduit through which first and second code segments communicate. FIG. 1C illustrates an interface as comprising interface objects I1 and I2 (which may or may not be part of the first and second code segments), which enable first and second code segments of a system to communicate via medium M. In the view of FIG. 1C, one may consider interface objects I1 and I2 as separate interfaces of the same system and one may also consider that objects I1 and I2 plus medium M comprise the interface. Although FIGS. 1B and 1C show bi-directional flow and interfaces on each side of the flow, certain implementations may only have information flow in one direction and/or may only have an interface object on one side.

Aspects of a programming interface may include the method whereby the first code segment transmits information (where “information” is used in its broadest sense and includes data, commands, requests, etc.) to the second code segment; the method whereby the second code segment receives the information; and the structure, sequence, syntax, organization, schema, timing and content of the information. In this regard, the underlying transport medium itself may be unimportant to the operation of the interface, whether the medium be wired or wireless, or a combination of both, as long as the information is transported in the manner defined by the interface. In certain situations, information may not be passed in one or both directions in the conventional sense, as the information transfer may be either via another mechanism (e.g. information placed in a buffer, file, etc. separate from information flow between the code segments) or non-existent, as when one code segment simply accesses functionality performed by a second code segment. Any or all of these aspects may be important in a given situation, e.g., depending on whether the code segments are part of a system in a loosely coupled or tightly coupled configuration, and so this description should be considered illustrative and non-limiting.

The concept of a programming interface is known to those skilled in the art. There are various other ways to implement a programming interface. Such other ways may appear to be more sophisticated or complex than the simplistic view of FIGS. 1B and 1C, but they nonetheless perform a similar function to accomplish the same overall result. Some illustrative alternative implementations of a programming interface are described in connection with FIGS. 1D-1M.

Factoring. A communication from one code segment to another may be accomplished indirectly by breaking the communication into multiple discrete communications. This is depicted schematically in FIGS. 1D and 1E. As shown, some interfaces can be described in terms of divisible sets of functionality. Thus, the interface functionality of FIGS. 1B and 1C may be factored to achieve the same result, just as one may mathematically provide 24, or 2 times 2 times 3 times 2. Accordingly, as illustrated in FIG. 1D, the function provided by interface Interface1 may be subdivided to convert the communications of the interface into multiple interfaces Interface1A, Interface1B, Interface1C, etc. while achieving the same result. As illustrated in FIG. 1E, the function provided by interface I1 may be subdivided into multiple interfaces I1a, I1b, I1c, etc. while achieving the same result. Similarly, interface I2 of the second code segment which receives information from the first code segment may be factored into multiple interfaces I2a, I2b, I2c, etc. When factoring, the number of interfaces included with the 1st code segment need not match the number of interfaces included with the 2nd code segment. In either of the cases of FIGS. 1D and 1E, the functional spirit of interfaces Interface1 and I1 remain the same as with FIGS. 1B and 1C, respectively. The factoring of interfaces may also follow associative, commutative, and other mathematical properties such that the factoring may be difficult to recognize. For instance, ordering of operations may be unimportant, and consequently, a function carried out by an interface may be carried out well in advance of reaching the interface, by another piece of code or interface, or performed by a separate component of the system. Moreover, one of ordinary skill in the programming arts can appreciate that there are a variety of ways of making different function calls that achieve the same result.

Redefinition. In some cases, it may be possible to ignore, add or redefine certain aspects (e.g., parameters) of a programming interface while still accomplishing the intended result. This is illustrated in FIGS. 1F and 1G. For example, assume interface Interface1 of FIG. 1B includes a function call Square(input, precision, output), a call that includes three parameters (“input,” “precision” and “output”) and which is issued from the 1st Code Segment to the 2nd Code Segment. If the middle parameter (“precision”) is of no concern in a given scenario, and as shown in FIG. 1F, it could be ignored or replaced with another parameter. In either event, the functionality of Square can be achieved, so long as output is returned after input is squared by the second code segment. Precision may very well be a meaningful parameter to some downstream or other portion of the computing system; however, once it is recognized that precision is not necessary for the narrow purpose of calculating the square, it may be replaced or ignored. For example, instead of passing a valid precision value, a meaningless value such as a birth date could be passed without adversely affecting the result. Similarly, as shown in FIG. 1G, interface I1 is replaced by interface I1′, redefined to ignore or add parameters to the interface. Interface I2 may similarly be redefined (as interface I2′) to ignore unnecessary parameters, or parameters that may be processed elsewhere. As is clear from the foregoing, a programming interface may in some cases include aspects such as parameters which are not needed for some purpose, and which may be ignored, redefined, or passed on for processing elsewhere for other purposes.

Inline Coding. It may also be feasible to merge some or all of the functionality of two separate code modules such that the “interface” between them changes form. For example, the functionality of FIGS. 1B and 1C may be converted to the functionality of FIGS. 1H and 1I, respectively. In FIG. 1H, the previous 1st and 2nd Code Segments of FIG. 1B are merged into a module containing both of them. In this case, the code segments may still be communicating with each other but the interface may be adapted to a form which is more suitable to the single module. Thus, for example, formal Call and Return statements may no longer be necessary, but similar processing or response(s) pursuant to interface Interface1 may still be in effect. Similarly, shown in FIG. 1I, part (or all) of interface I2 from FIG. 1C may be written inline into interface I1 to form interface I1″. As illustrated, interface I2 is divided into I2a and I2b, and interface portion I2a has been coded in-line with interface I1 to form interface I1″.

Divorce. A communication from one code segment to another may be accomplished indirectly by breaking the communication into multiple discrete communications. This is depicted schematically in FIGS. 1J and 1K. As shown in FIG. 1J, one or more piece(s) of middleware (Divorce Interface(s), since they divorce functionality and/or interface functions from the original interface) are provided to convert the communications on the first interface, Interface1, to conform them to a different interface, in this case interfaces Interface2A, Interface2B and Interface2C. This might be done, e.g., where there is an installed base of applications designed to communicate with, say, an operating system in accordance with an Interface1 protocol, but then the operating system is changed to use a different interface, in this case interfaces Interface2A, Interface2B and Interface2C. The point is that the original interface used by the 2nd Code Segment is changed such that it is no longer compatible with the interface used by the 1st Code Segment, and so an intermediary is used to make the old and new interfaces compatible. Similarly, as shown in FIG. 1K, a third code segment can be introduced with divorce interface DI1 to receive the communications from interface I1 and with divorce interface DI2 to transmit the interface functionality to, for example, interfaces 12a and 12b, redesigned to work with DI2, but to provide the same functional result. Similarly, DI1 and DI2 may work together to translate the functionality of interfaces I1 and I2 of FIG. 1C to a new operating system, while providing the same or similar functional result.

Rewriting. Yet another possible variant is to dynamically rewrite code to replace the interface functionality with something else but which achieves the same overall result. For example, there may be a system in which a code segment presented in an intermediate language (e.g. Microsoft IL, Java ByteCode, etc.) is provided to a Just-in-Time (JIT) compiler or interpreter in an execution environment (such as that provided by the .Net framework, the Java runtime environment, or other similar runtime type environments). The JIT compiler may be written so as to dynamically convert the communications from the 1st Code Segment to the 2nd Code Segment, i.e., to conform them to a different interface as may be required by the 2nd Code Segment (either the original or a different 2nd Code Segment). This is depicted in FIGS. 1L and 1M. As can be seen in FIG. 1L, this approach is similar to the Divorce scenario described above. It might be done, e.g., where an installed base of applications are designed to communicate with an operating system in accordance with an Interface1 protocol, but then the operating system is changed to use a different interface. The JIT Compiler could be used to conform the communications on the fly from the installed-base applications to the new interface of the operating system. As depicted in FIG. 1M, this approach of dynamically rewriting the interface(s) may be applied to dynamically factor or otherwise alter the interface(s), as well.

It is also noted that the above-described scenarios for achieving the same or similar result as an interface via alternative embodiments may also be combined in various ways, serially and/or in parallel, or with other intervening code. Thus, the alternative embodiments presented above are not mutually exclusive and may be mixed, matched and combined to produce the same or equivalent scenarios to the generic scenarios presented in FIGS. 1B and 1C. It is also noted that, as with most programming constructs, there are other similar ways of achieving the same or similar functionality of an interface which may not be described herein, but nonetheless are represented by the spirit and scope of the invention.

III. Enhanced File Dialogs

As used herein, a “file dialog” is a dialog created for the purpose of opening, saving or otherwise indicating a file is to be processed and/or how a file is to be processed. Although embodiments of the invention will be described by reference to examples of dialogs for opening and for saving files, the invention is not limited in this regard. Other examples of file dialogs include dialogs for inserting file attachments, for importing files, etc. As used herein, the word “file” is given a broad meaning and generally refers to a collection of information accessible by a computer. A file may include text, programming instructions and/or various other types of data. A file may be identified to a user as document, a photograph, or some other type of item for which the file contains data. A file may also be fragmented or otherwise stored in one or more physical locations on a disk or other storage medium.

The invention is not limited to files stored in conventional hierarchical file tree structures. In at least some embodiments, files may have multiple metadata attributes (alternatively referred to as “properties”). Using values for those attributes, files may then be grouped into collections of interest to a user. By way of illustration, files on one computer may have metadata attributes such as file author, a customer to which the file pertains, and file type. User A then creates spreadsheet, word processing and slide show presentation files regarding customers X, Y and Z and stores all of those files in a directory subfolder “C:\Users\User_A\”. User B creates spreadsheet, word processing and jpeg image files for those same customers. User B stores spreadsheet and word processing files in “C:\Users\User_B\”, but stores image files in “C:\Media\Photos\”. All of these files are then accessible based on lists. For example, a “Client X” list groups all spreadsheet, word processing, slide show and jpeg files for client X, regardless of author. By specifying the Client X list, the user is able to see a grouping of those files without having to separately navigate through multiple subdirectories. These “author,” “customer” and “file type” metadata attributes are provided for purposes of illustration. Other examples include properties such as rating, comments, project, etc. A very large number of metadata attribute types can be implemented, and the invention is not limited by type of metadata attribute.

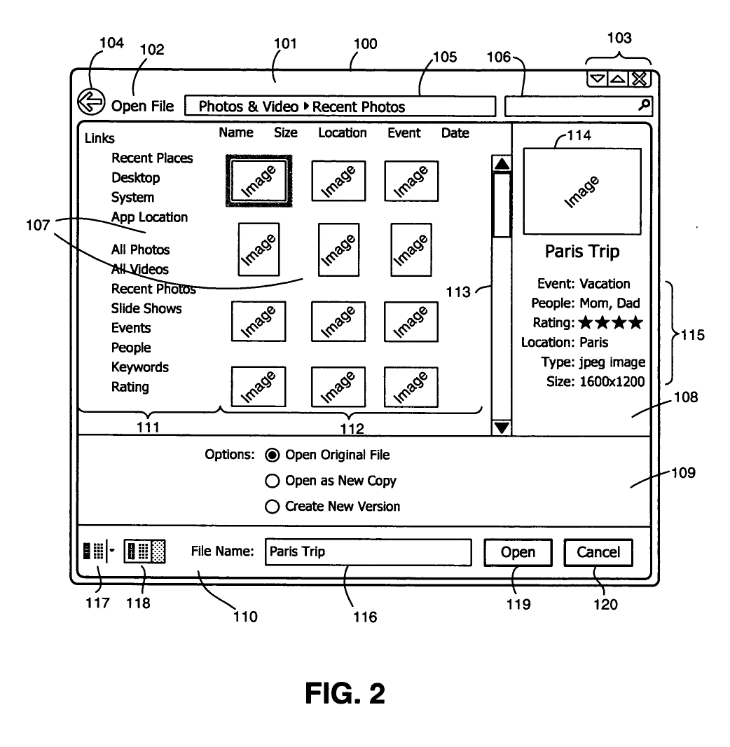

Shown in FIG. 2 is an “Open File” dialog 100 according to at least some embodiments of the invention. Although the example dialogs in the drawings are shown as independent windows in a graphical user interface (GUT) generated by an OS (such as various versions of the WINDOWS OS), the invention is not limited in this regard. For example, a file dialog according to the invention might also be generated as a pane of (or frame within) a pre-existing window. Open File dialog 100 is contained in a frame 101 of a dialog window and has a title 102. Controls 103 respectively permit a user to minimize, maximize or close dialog 100. Arrow 104 is a “back” control which a user can select to return to file groupings which the user has previously viewed. Adjacent to title 102 are a navigation bar 105 and a search bar 106, both of which are described below.

Open File dialog 100 is divided into four regions 107-110. Browser region 107 includes a places bar subregion 111 and a pagespace subregion 112. Entries in places bar 111 correspond to lists, directory locations or other groupings of files, and represent “places” to which a user may navigate to locate files. Selecting one of the entries in places bar 111 causes a corresponding display in pagespace region 112. In some cases, that display may be a collection of icons corresponding to files in the selected place (e.g., the selected list or other grouping). In some cases, and similar to the WINDOWS EXPLORER component of the WINDOWS XP OS, selecting a particular places bar entry may display a collection of file icons together with icons for one or more folders, directories or other locations to which a user might navigate. One or more entries in places bar 111 may be expandable to show sublists or other subgroupings of documents. For example, the “People” entry in FIG. 2 could be expandable to reveal lists of files pertaining to (i.e., having the appropriate metadata attribute values corresponding to) different individuals.

In the example of FIG. 2, the user has selected the places bar entry corresponding to a “Recent Photos” list, and is thus presented in pagespace 112 with a collection of thumbnail images corresponding to files in that list. The user can then sort those files based on property values for file name, file size, location, event, or date of file creation by selecting “Name,” “Size,” “Location,” “Event” or “Date” at the top of pagespace 112. The categories by which files in pagespace 112 can be sorted may change based on the selected entry on place bar 111. Similarly, the manner in which files are shown in pagespace 112 can vary based on file type. A text file may be represented as a thumbnail image of the first page of the document saved in that file. In some cases, a file might be represented by an icon corresponding to the application program which created the file (or with which the file is otherwise associated). A scroll bar 113 allows the user to see additional files.

After selecting one of the files displayed in pagespace 112, more detailed information for that file is provided in infopane region 108. Displayed in infopane region 108 is a larger preview (or “ghost”) 114 of the selected file, together with values 115 for various metadata attributes. Although the example of FIG. 2 shows selection of an image file, the invention is not limited in this regard. For example, one or more of the files displayed in pagespace 112 might be a text file. Upon selection of such a file, an image of the first page of that text file would be shown as ghost 114. Of course, the properties and values shown in infopane region 108 for a selected file can vary. Using the earlier example of User A and User B, selection of a file in a “Client X” list could show values for author and client in infopane region 108.

Returning to navigation bar 105, the user is provided with information indicating the “trail” which the user followed to reach the current pagespace display. In the example of FIG. 2, the user first navigated to a “Photos & Videos” list, and then to a “Recent Photos” sublist. The user can then use search bar 106 to locate files, within the current pagespace, based on title or keyword values.

Below browser region 107 and infopane region 108 is an extensibility region 109. As explained in more detail below, an extensibility region of a file dialog may contain any of a wide variety of user interface (UI) controls which may be specified by the developer of the software program which instantiates the dialog 100. As used herein, a “UI control” includes various types of graphical elements which a user can select (by, e.g., hovering a cursor over the control and pressing a mouse button) so as to interact with the application (or other computer program) that instantiated the dialog. UI controls include, but are not limited to, push (or “command”) buttons, “radio” buttons, check boxes, text input (or “edit”) boxes, etc. UI controls also include graphical elements which only provide information to a user (i.e., which do not offer a user the chance to select something or otherwise provide input). Examples of such information-only UI controls include a block of text or a spacer dividing other UI controls. FIG. 2 only shows a set of radio button controls and a text label (“Options”) for those radio buttons. Examples of other types of controls are described below. In at least some embodiments, extensibility region 109 is optional, and a developer could omit it altogether.

Below extensibility region 109 is command region 110. Command region 110 includes a text entry control 116 which permits entry of the name of a file a user wishes to open. Although not shown, command region 110 could also include a control allowing a user to input (or select from a drop-down list) the type of file which the user wishes to open. This control would be useful if, e.g., two files of different types have the same title (e.g., “report.DOC” and “report.PDF”). A view control 117 allows a user to change the way in which files are shown in pagespace 112. Instead of a collection of icons, for example, a user may instead wish to see files identified in a “details” mode (not shown) providing a table of file names, types, sizes, etc. In at least some embodiments, the view mode is based on a default view associated with the list or other location to which a user has navigated in browser region 107. A developer can set the default view mode for any location, and a user may be permitted to override the view mode settings. When in “details” mode, the columns displayed are also based on the location to which a user has navigated, but a developer can specify (and a user can override) which columns are visible.

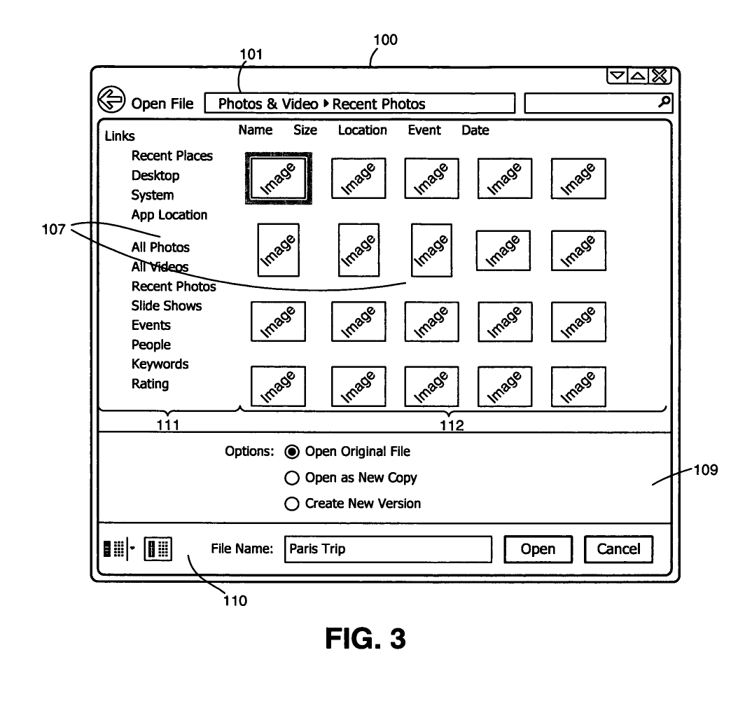

Control 118 allows a user to change the appearance of dialog 100 such that infopane region 108 is not displayed (see FIG. 3), or if infopane region 108 is already hidden, to show infopane region 108. Command button 119 permits a user to open a file which has been selected in pagespace 107 or identified in control 116. Command button 120 permits a user to cancel dialog 100. A developer may also override the default button labels and specify other text (e.g., change the “Open” button to “Check Out”).

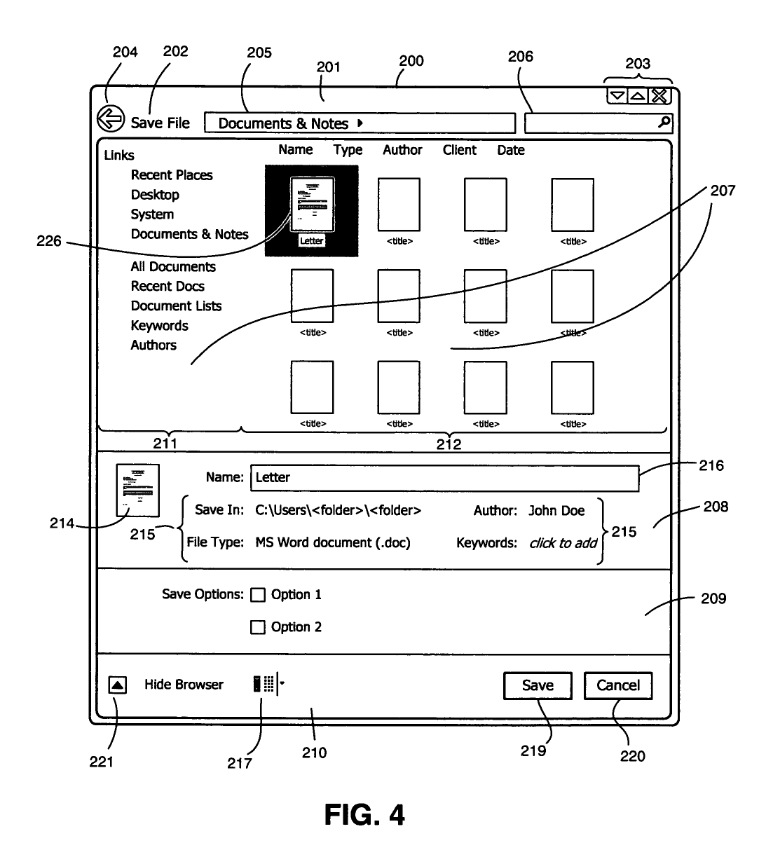

Shown in FIG. 4 is a “Save File” dialog 200 according to at least some embodiments of the invention. Save File dialog 200 is contained in a frame 201 of a dialog window and has a title 202. Controls 203 and back arrow 204 operate similar to controls 103 and 104 in Open File dialog 100 of FIG. 2. Navigation bar 205 and search bar 206 function similar to navigation bar 105 and search bar 106 of Open File dialog 100. Save File dialog 200 also includes a browser region 207 having places bar 211 and pagespace 212. As with Open File dialog 100 (FIG. 2), selection of an entry in places bar 211 results in display in pagespace 212 of information about files associated with a list, directory folder or other file grouping, and/or a display of icons permitting navigation to other locations. Files displayed in pagespace 212 can similarly be sorted using the controls (“Name,” “Type,” etc.) at the top of pagespace 212.

Save File dialog 200 further includes an infopane region 208. In at least some embodiments, and as shown in FIG. 4, infopane regions for Save File dialogs are located beneath the browser region. Infopane region 208 includes a ghost 214 of the file to be saved. Depending on the type of file being saved, ghost 214 may be a thumbnail image of the document, picture or other item stored in the file, may be an icon corresponding to an application associated with the file, or may be some other type of graphical representation. A file name control 216 allows a user to enter a name for the file being saved. This field may have a file name suggested by an application program instantiating the File Save dialog (e.g., the first words of the file being saved). In some cases, the user may be replacing an existing file by selecting a file from pagespace 212, in which case the filename for the replaced file may be automatically added to control 216. In other cases, a user may be unsure about where a file should be stored. Using places bar 211, the user can navigate to one or more lists or other file groupings and find an appropriate location. As the user navigates through such groupings, he can see information in pagespace 212 regarding other files in those groupings and use that information to determine if the current file should be saved to one of those groupings. In some cases, a ghost 226 of the file being saved is also shown in pagespace 212 as the user navigates through various possible locations for the file. In this manner, the user is provided with a visual indication of the location in which he or she can later find the file. The presence of ghost 226 in pagespace 212 also signals that the current list or other grouping is a valid save location.

Also shown in infopane region 208 are fields 215 for various metadata regarding the file being saved. In some cases, a user may select one or more of these fields to add a metadata value. For example, the user might select the “keywords” field and add words which might make the file easier to find in a future keyword search. In other cases, a value for one of the metadata fields may be populated (at least initially) by an application instantiating dialog 200. In still other cases, a value of a metadata field might be automatically populated based on the selected storage location for the file. If, for example, a user saves a file in a “project X” list, a metadata field for “project” (not shown in the drawings) would be automatically populated with “X”. As with Open File dialog 100, the metadata categories and values shown in infopane region 208 for a file can vary.

Below infopane region 208 is an extensibility region 209. Similar to extensibility region 109 of Open File dialog 100, the extensibility region of a Save File dialog may contain any of a wide variety of user interface (UI) controls which a software developer may specify. Although a pair of check boxes are shown in FIG. 4, other UI controls could be included. Extensibility region 209 is optional in at least some embodiments. Stated differently, a developer would be free to create a Save File dialog without an extensibility region.

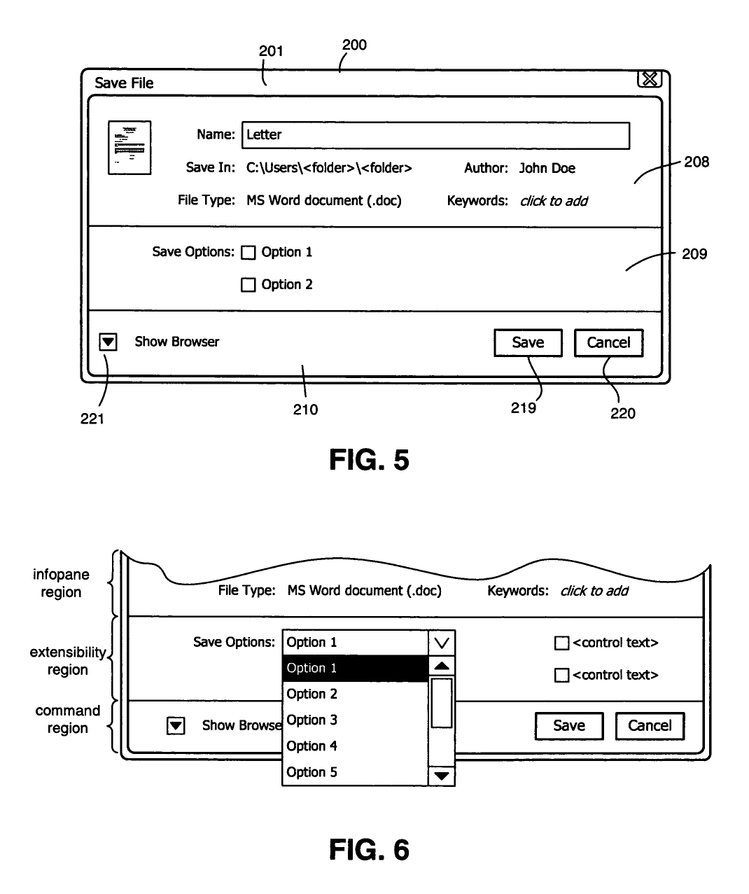

Below extensibility region 209 is command region 210. Command region 210 contains a command button 219 for saving a file to a selected location, as well as a command button 220 for canceling Save File dialog 200. Text for these buttons can be changed by a developer (e.g., changing “Save” to “Check In”). Also included in command region 210 is a control 221 for hiding browser region 207. By selecting this control, and as shown in FIG. 5, browser region 207 is no longer displayed. In this manner, a more compact Save File dialog can be provided. Navigation bar 205 and search bar 206, and/or the minimization and maximization arrows of controls 203, may also be removed in a compacted Save File dialog. By reselecting control 221 (the label for which has changed to “Show Browser” in FIG. 5), browser region 207 is again displayed. A view selection control 217 (FIG. 4) is visible when browser region 207 is displayed, and functions similar to view selection control 117 of Open File dialog 100 (FIG. 2). As with Open File dialog 100, the default view mode (e.g., icons vs. details) when the Save File browser is displayed is based on the list or other location to which a user has navigated. A developer can similarly set (and a user can override) a view mode setting and the columns shown when in the details view mode.

As seen by comparing FIGS. 2 and 4, the location of infopane region 108 in Open File dialog 100 is different from that of infopane region 208 of Save File dialog 200. This repositioning corresponds to the different purposes of these two types of dialogs. A user is typically looking for a particular file in an Open File dialog. A graphical depiction of the file contents is often more helpful than detailed metadata. Accordingly, the focus of the infopane region in an Open File dialog is typically on file preview, and the infopane is positioned to allow for a larger ghost image. The focus of the infopane region in a Save File dialog is on editing and on proper storage of a file for future retrieval. Thus, the infopane region of a Save File dialog is positioned to encourage entry and/or modification of metadata.

In at least some embodiments, metadata fields are displayed in an infopane region of both Open File and Save File dialogs based on a predetermined order. In particular, system-required metadata attributes (e.g., file name, file type, location for saving) are shown first. Next shown are metadata attributes required by an application instantiating the dialog, but which are not necessarily required in all applications (e.g., compression ratio, file protection). Remaining properties are then shown. The infopane region (and the entire dialog, if necessary) is automatically resized so as to show all system- and application-required properties. In at least some embodiments, an application program cannot specify what metadata is required, but the application can “promote” metadata types to have a priority such that corresponding fields will be displayed in a default-sized dialog.

Shown in FIGS. 2 and 4 are two of the various types of UI controls which a developer can place in an extensibility region of an Open File or a Save File dialog. A developer may include multiple controls of the same type and/or may combine controls of different types. FIG. 4 shows a pair of verification (or “check box”) UI controls. Such a UI control can include text (“Option 1” and “Option 2”) and may contain a label applicable to multiple check boxes (“Save Options”). A user can place a check in (or remove a check from) a check box with a mouse. The checked/unchecked state of the control is then returned to a program. In at least some embodiments implemented in LTR (left-to-right) languages, text for a check box control is left aligned and wraps to the column in which the control is located. Labels in an extensibility region may be automatically aligned with metadata field labels in an infopane region. As seen in FIG. 4, the “Save Options” label in extensibility region 209 is aligned with “Save In” and “File Type” in infopane region 208. As explained in more detail below, UI controls in an extensibility region may also be organized into one or more groups and displayed in multiple columns.

FIG. 2 shows a collection of radio button UI controls. Each radio button control typically displays one or more lines of text (e.g., “Open Original File”) for a possible input option. Next to the text for each option is a small circle or other region which a user can select with a mouse. Once selected, the region is filled with a black dot or other indication of the selection. Typically, only one of the options can be selected. If a user selects one option and then selects another of the options, the black dot for the first selection is removed. Radio button controls may also include a label (“Options”). In at least some embodiments implements in LTR languages, text for a radio button control is left aligned and wraps to the column in which the control is located.

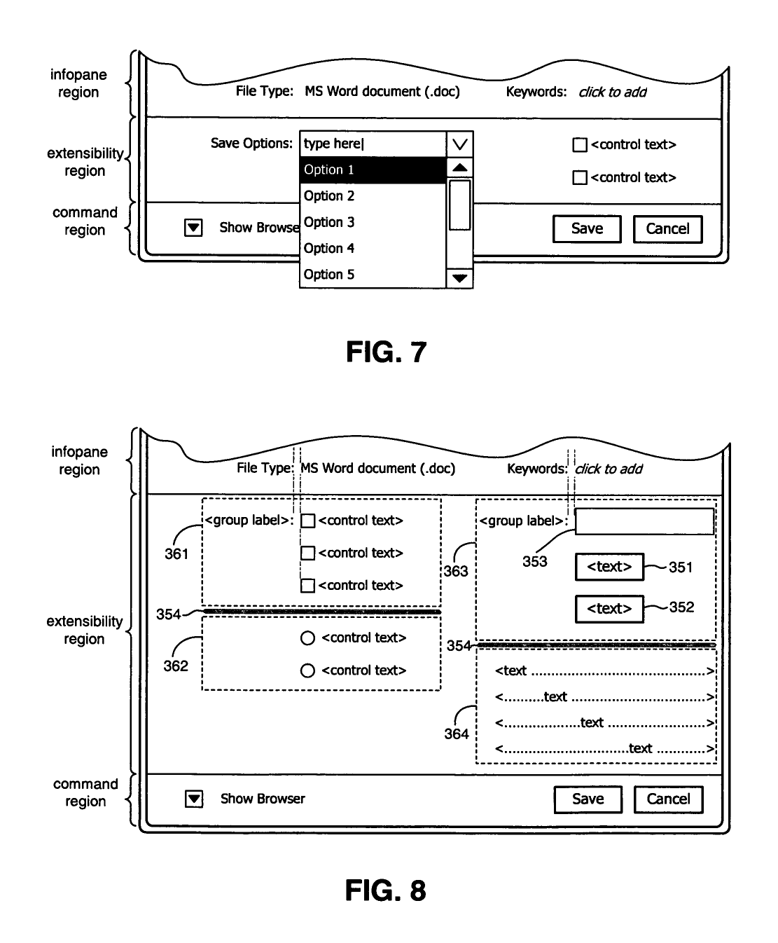

Shown in FIGS. 6-10B are various other types of UI controls which a software developer can specify for inclusion in an extensibility region. Although FIGS. 6-10B show these other types of UI controls in an extensibility region of a Save File dialog, these UI controls could also be included in an Open File dialog (or other type of file dialog) extensibility region. FIG. 6 shows a drop-down box control. As seen in FIG. 6, a drop-down box permits a user to expand a box to show a list of possible selections. An option selected from the drop-down list is then automatically placed in the box. FIG. 7 shows a combo-box control. This UI control allows a user to expand a box into a list of possible selections (similar to a drop-down box), but also permits the user to type text into the box (shown in FIG. 7 as “type here”).

FIG. 8 shows push button UI controls 351 and 352, as well as edit box control 353. Also illustrated in FIG. 8 is grouping of UI controls. In at least some embodiments, a control group can include one or more controls and a label applicable to controls in the group. In the example of FIG. 8, four groups are shown. Group 361 contains a group label and three check box UI controls. Group 362 does not have a group label, but does include two radio button UI controls. Group 363 includes a group label, an edit box UI control 353, and two push button UI controls 351 and 352. Group 364 contains plain text, e.g., text not labeling or associated with a specific control. Although groups 361-364 are outlined in FIG. 8 for purposes of explanation, such outlines would not necessarily appear in an actual dialog. A separator 354 can be specified for placement between control groups. In at least some embodiments, a separator only spans a single column, and is added as the last element of a group. Separators appearing as the first or last column element are hidden. In at least some embodiments, and as seen in FIG. 8, controls in a group are kept together in the same column of an extensibility region when the dialog is displayed. In some embodiments, and as also seen in FIG. 8, the right edges of UI control group labels in a Save File dialog extensibility region are automatically aligned with the right edges of metadata labels (“File Type” and “Keywords”) in an infopane region. The left edges of UI controls in a Save File dialog extensibility region are similarly automatically aligned with the left edges of metadata value fields in the infopane region. Plain text is automatically left aligned and wraps to the column in which the text is contained.

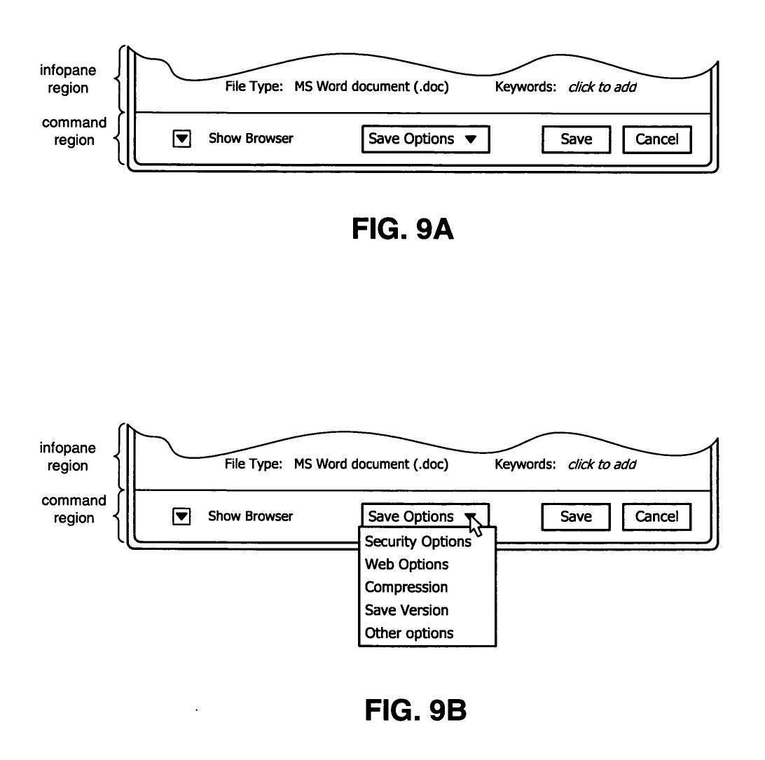

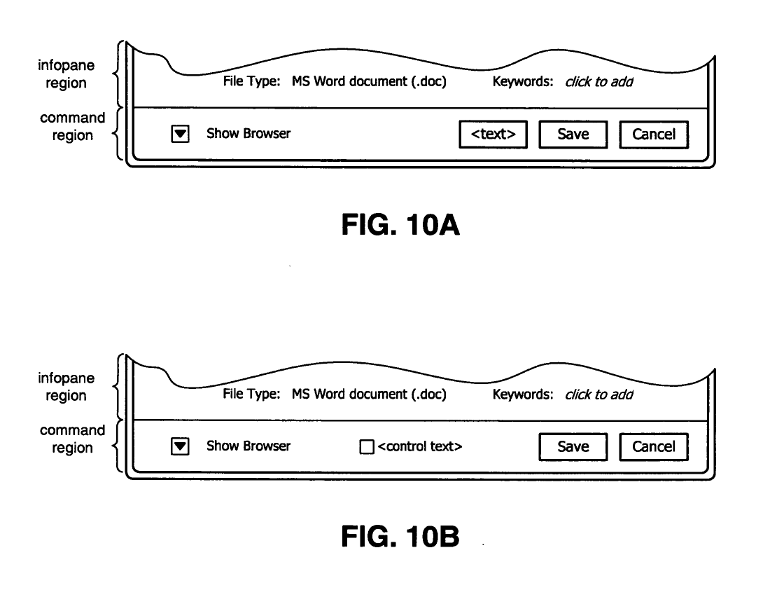

In some embodiments, a drop-down menu UI control can be included in a command region, as shown in FIGS. 9A and 9B. Selection of the menu reveals a list of selectable options. Selecting some options may result in display of submenus and/or other dialogs. In some cases, a drop-down menu and command button can be combined into a “split button” UI control, which can also be located in the command region. A split button UI permits a user to select an option in a drop-down menu. The split button is then relabeled with the selected option, and the user can then press the button to act on the selected option. Other controls can also be added to a command region, as shown in FIGS. 10A (push button UI control “<text>”) and 10B (check box UI control). This may be desirable if a developer only needs to include a single specialized control, and avoids consuming display area for an extensibility region. In at least some embodiments, a developer is not able to add radio button groups and labels to a command region. Inclusion of a control in the command region also permits a developer to emphasize that control and/or to separate that control from controls in an extensibility region. Thus, a developer might specify certain controls for the extensibility region and a control for the command region. In other embodiments, however, no additional controls are placed in a command region if the extensibility region will be displayed (e.g., if there are to be two or more UI controls added), with the exception of menu UI controls. Menus often contain choices applicable to multiple dialogs instantiated by an application, and allowing a menu in the command region may be more efficient in some cases. In some embodiments, menus are always located in the command region.

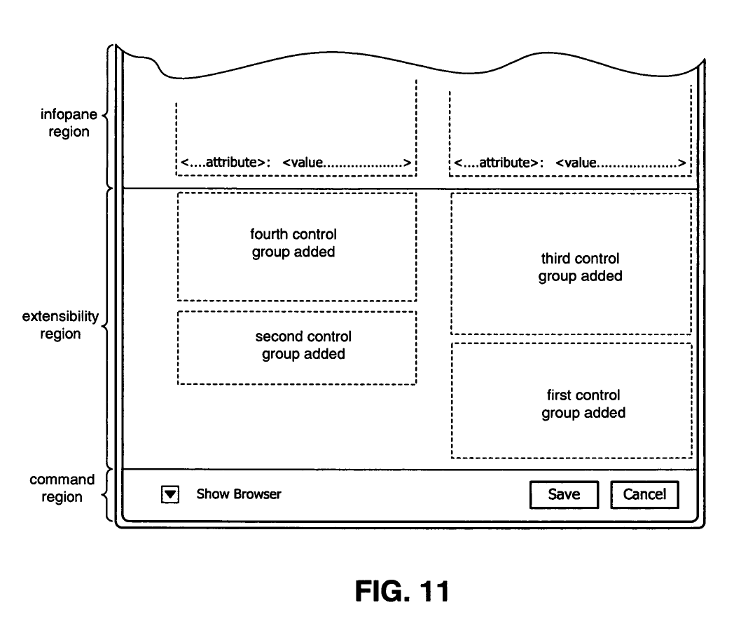

In at least some embodiments, arrangement and appearance of UI controls in an extensibility region is automatic. The application instantiating the dialog simply identifies to the OS (via one or more programming interfaces) the UI controls and/or groups desired. The OS then controls the arrangement and appearance. A control not explicitly added to a group is treated as its own group. The OS places each group in the extensibility region based on the order in which the UI control or group is first identified in the programming interface(s). FIG. 11 illustrates the automatic layout of control groups in a Save File dialog. As seen in FIG. 11, the metadata field label/value pairs in a Save Dialog infopane region form two columns. Control groups are then added in the extensibility region, aligned with those columns, so as to minimize height of the extensibility region. Spacing between groups, as well as between individual controls within a group, is also automatic. In other words, an application developer need not precisely specify the position of each UI control. Similarly, the appearance of text for UI controls, group labels and plain text is automatically controlled by one or more OS theme files.

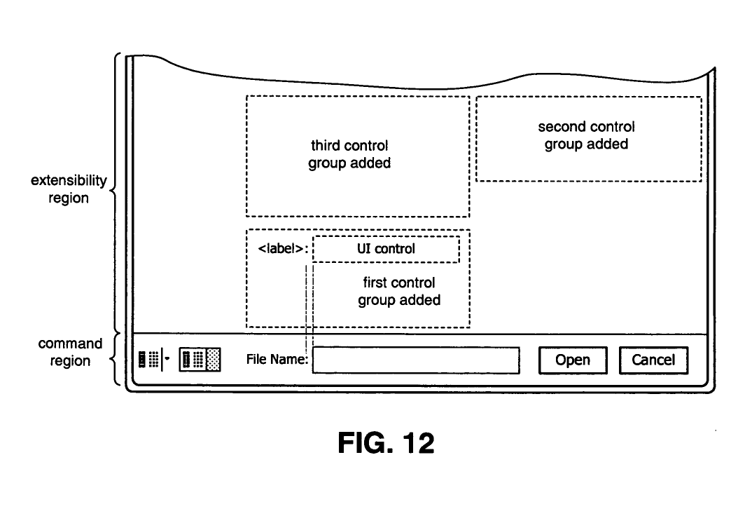

FIG. 12 shows automatic layout of UI controls in an Open File dialog according to at least some embodiments. As seen in FIG. 2, the infopane region of an Open File dialog is arranged differently than the infopane region of a Save File dialog. Accordingly, UI controls and UI control groupings in an Open File dialog extensibility region are aligned with the “File Name” label and corresponding text box control in the command region. If more than one control grouping is specified for an Open File dialog extensibility region, a second column is used. In at least some embodiments, and similar to Save File dialogs, an application instantiating an Open File dialog simply identifies the UI controls and/or groups to the OS via one or more programming interfaces. The OS then controls the arrangement and appearance of the UI controls. Control groups are added to an Open File dialog in the order in which those control groups were specified by the developer and are automatically laid out so as to minimize height of the extensibility region. Spacing, text font, etc. is controlled by one or more OS theme files.

In addition to specifying UI controls for inclusion in an extensibility region (and in some cases, a command region), an application developer can customize a file dialog in various other ways. Using appropriate programming interfaces (as discussed below), a developer can override the dialog titles (e.g., “Open File” title 104 in FIG. 2, “Save File” title 204 in FIG. 4) and cause some other title to be displayed. A developer can also make choices which will affect the locations to which a dialog will navigate when a dialog is opened. In particular, when a dialog such as shown in FIG. 2 or FIG. 4 is first opened, the dialog will often show a particular list or other file grouping as a suggested location in which to save (or from which to open) a file. In some embodiments, a file dialog first attempts to navigate to one of the following locations (listed in order of preference): (1) a location that the instantiating application specifies (e.g., the last location visited by the application), (2) last location to which a file was opened or saved by that application (as tracked by the OS), (3) a default location specified by the application, or (4) an OS-specified default location (e.g., a root directory, the desktop in the WINDOWS OS, etc.).

An application developer can also specify the initial browser mode. In some embodiments, for example, a Save File dialog automatically opens with the browser region hidden unless an application requests otherwise. In certain embodiments, Open File dialogs are always displayed with a browser region. An OS generating a file dialog in response to an application request may also render the dialog at a default size and in a default location on the screen. For example, the OS may automatically locate the dialog in the center of the display and limit the dialog and/or various regions of the dialog to certain sizes. An application developer can override these default values by specifying a size and/or location for the dialog. This may occur by explicitly supplying values for size and/or location. This may also occur implicitly. For example, an application may specify more controls for an extensibility region than can be contained within a default size.

As with other windows in a display, a user may also be able to move and/or resize the dialog. Similarly, a user can resize the browser region (if shown) and the infopane region. As the infopane region is expanded (by, e.g., selecting the edge of the infopane region with a mouse and pulling the edge across the screen), additional metadata property/value pairs become visible. As the infopane region is contracted, fewer property/value pairs can be seen. User changes to size or position of a dialog or dialog region (as well as changes to view mode, visible columns in a details view mode, etc.) can be persisted until the user completes or cancels the dialog. In some embodiments, some or all of such user changes may be persisted in subsequent dialogs.

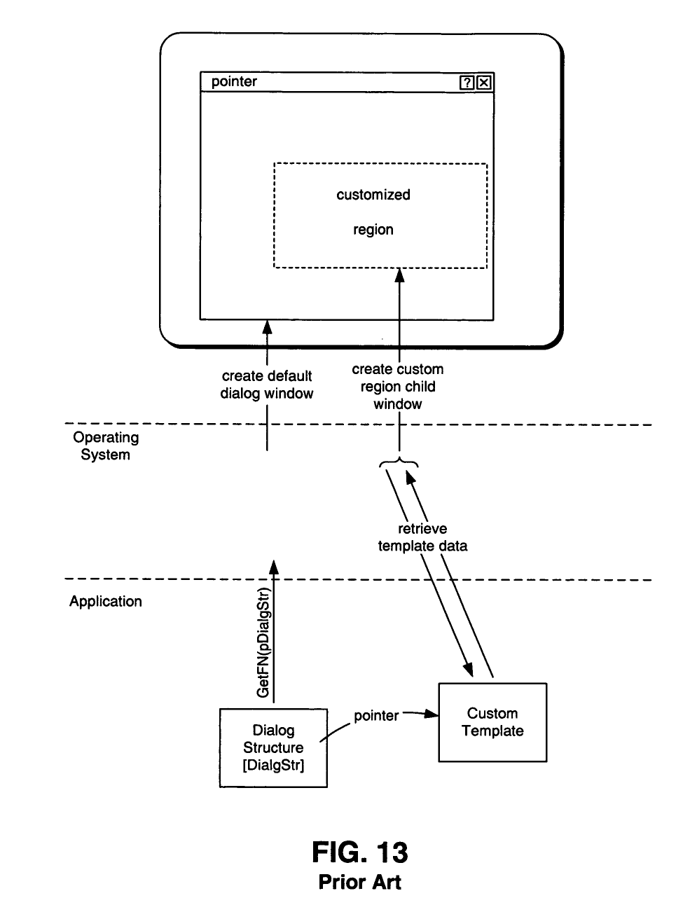

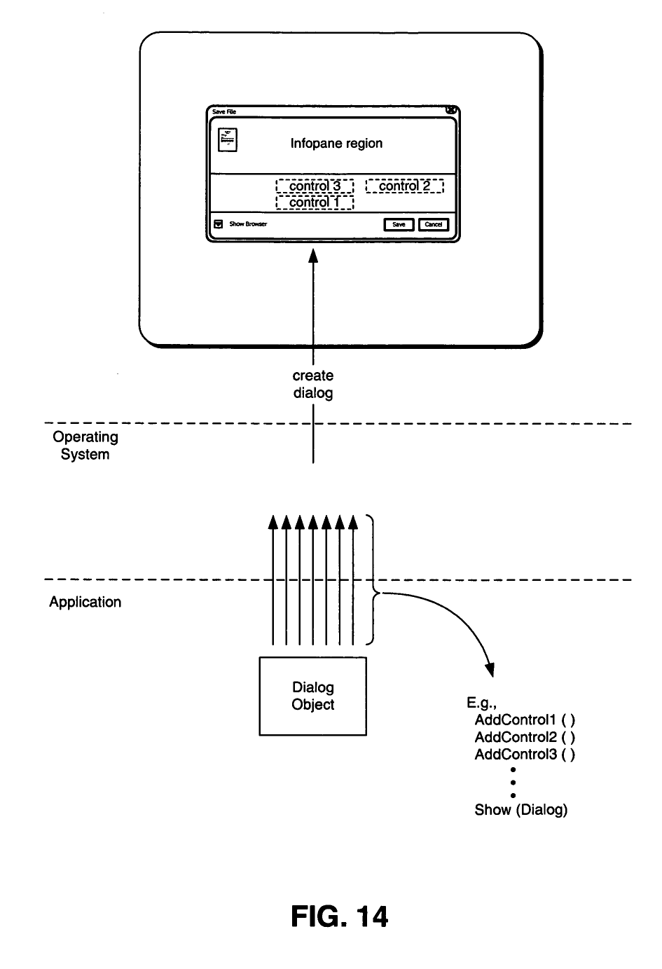

FIGS. 13 and 14 are block diagrams illustrating differences between the manner in which an application requests generation of a file dialog according to embodiments of the invention and the manner in which a file dialog is requested in the prior art. FIG. 13 is a block diagram illustrating an existing manner in which an application program requests display of a file dialog from various versions of the WINDOWS OS. In FIG. 13, the application first creates a data structure (“DialgStr”) corresponding to the dialog to be displayed. This structure contains values for numerous variables and flags that control the behavior of the dialog. In various versions of the WINDOWS OS, this structure is an “OPENFILENAME” structure. In order to instantiate a dialog, the application then calls an OS function that has a pointer to the DialgStr structure as an argument. Specifically, the application calls the “GetOpenFileName” function to instantiate a dialog for opening a file and the “GetSaveFileName” function to instantiate a dialog for saving a file. For simplicity, these functions are shown generically in FIG. 13 as “GetFN(pDialgStr)”. In response to this function call, the OS then generates a window containing a default dialog.

If an application developer wishes to customize a default dialog so as to include custom UI controls, additional steps are needed. Specifically, the developer must create a custom template for the portion(s) of the default dialog that define the region(s) to hold the customized UI controls. A pointer to that template is then included in the DialgStr structure. The OS retrieves data from the custom template and uses that data to create the customized controls within a child window of the default dialog.

At first glance, the procedure of FIG. 13 seems straightforward. However, the custom template must specify all the desired custom UI controls and their positions, how the controls will be displayed, etc. Creating a custom template can be a significant effort for the application developer. Moreover, the developer must also create callback functions to deal with user input received by the custom UI controls.

The procedure of FIG. 13 also poses problems to the OS developer. Few limits are imposed upon what an application developer may include in a customized region of a default dialog. Similarly, few limits are imposed on where an application developer may place a customized region within a default dialog. Although FIG. 13 shows all the customized controls inside a single contiguous block, this is not always the case. A custom template can specify numerous custom controls to be placed in multiple child windows of the default dialog, and the customized region(s) may have various shapes. In view of all these factors, it is difficult (if not impossible) for the OS developer to know all of the ways in which various applications customize default dialogs. In turn, this increases the difficulties in upgrading the OS. For example, a change to the default dialog format that adds a new element in a particular location may be incompatible with applications instantiating dialogs with customization in the same location.

FIG. 14 is a block diagram illustrating creation of a file dialog according to embodiments of the invention. The application developer creates an object which corresponds to the dialog to be displayed. The object is an instantiation of an object class made available by the OS. Once created, the object automatically includes methods which the application can call in order to display the dialog, to add controls to the dialog, and to otherwise set the behavior of the dialog. This is shown schematically in FIG. 14, where the application has called various methods of an instantiated dialog object in order to add certain controls to the dialog (e.g., “AddControl1( )”, etc.). Other methods are called (and/or specified variable values and/or flags included in those calls) to control other aspects of the dialog's appearance and behavior. Set forth below are examples of actions that a developer can perform via calls to these methods.
Add a dropdown box.
Enable opening a dropdown menu.
Add a menu.
Add a command button.
Add a combo box.
Add radio buttons.
Add a check box.
Add a text entry box.
Add a separator.
Add text.
Group controls.
Set a label for controls.
Retrieve a control state.
Set a control state.
Retrieve text in a text entry box.
Set text in a text entry box.
Add a control (e.g., to an already displayed dialog).
Make a control more prominent.
Remove a control item.
Set the files types that the dialog can open or save (for Open File dialogs, the file types can be used to filter the view for the user; for Save File dialogs, the file types can determine which extension to be appended to a user-specified file name).
Set the currently selected file type.
Retrieve the currently selected file type.
Attach an event handler to listen for events from the dialog.
Set flags to control dialog behavior, including:
   whether to prompt a user for confirmation before overwriting a file (Save File dialogs),
   whether to require that the file extension for a file name returned by a user match that of a currently selected file type (Save File dialogs),
   whether to require that an item name returned by a user be a file system item,
   whether a user can select multiple files for opening,
   whether a user is required to specify a file in an existing folder,
   whether a file to be opened must already exist,
   whether a user is prompted to create an item identified by the user (e.g., folder or list) that does not already exist, and
   behavior on detecting a sharing violation.
Retrieve the current settings on various flags.
Set a folder or other location in which the dialog will open.
Retrieve the user's current selection(s) in the dialog.
Retrieve the current folder which the dialog is showing or to which the dialog will open (if the dialog is not currently displayed).
Retrieve the current text in the file name text box UI control.
Set the title of the dialog.
Set the text of the “Open” or “Save” button.
Set text of the label next to the file name text box UI control.
Retrieve a choice a user has made in a displayed dialog.
Add a place to the places bar.
Set a default extension for file names typed by a user.
Close the dialog.
Associate an identifier with the state of a dialog (e.g., last visited folder, position, size) so that the state will persist.
Clear a persisted state for a dialog.
Set a name that will initially appear in a file name field.
Specify metadata attribute values to be collected in a save dialog.
Set a property store for a file being saved.
Specify whether an application can retrieve the current metadata values in an infopane region or must wait and receive a final set of values after the dialog has closed.
Apply a set of properties to a file.
Prevent a dialog from closing (if, e.g., a user has entered an invalid choice).

Based on the methods called (shown as arrows from the dialog object in FIG. 14), the OS creates the requested dialog. As previously discussed, the arrangement of UI controls is set by the OS. Accordingly, detailed placement information for the UI controls (e.g., specifying pixel x and y offsets from a reference location) need not be provided by the application developer. Because dialog customization is facilitated by calls to methods within the dialog object, and because the manner in which those methods can customize a file dialog are known to the OS developer, the OS developer is more able to know how OS modifications will affect applications. In particular, customized controls are limited to those which can be specified via one of the method calls. Because those UI controls will be placed within a known region of a dialog, the OS can later be modified to change other parts of the dialog.

In addition, a number of dialog object methods can be called by the OS to inform the application of various events. The application can then perform desired actions in response. For example, user selection of a control corresponding to password protection of a specified file could result in the application taking appropriate steps to protect that file (either directly or via a programming interface to the OS or to another application). Set forth below are examples of events about which the OS can inform an application via calls to such methods.
The dialog is about to close.
The user has navigated (or is navigating) to a new folder.
A help button has been pressed.
A user view selection has been made.
A file sharing violation has occurred.
A file type selection has changed.
The user has indicated a file should be overwritten.
A new selection has been made in a combo box, in a collection of radio buttons or a menu.
A command button has been pressed.
A check box state has changed.
A drop down menu on a button is about to be opened.

Although specific examples of carrying out the invention have been described, those skilled in the art will appreciate that there are numerous other variations and permutations of the above described systems and techniques. As but one such variation, some or all of the UI controls in the extensibility region or elsewhere in the dialog may be selectable using a keyboard. For example, a user might press a tab key to highlight a particular control and then activate that control by pressing the “Enter” key. As another example, a particular control may have a corresponding key combination (e.g., “Alt+S”). In at least some embodiments, an application developer can modify aspects of how a user accesses a dialog via a keyboard. There might also be multiple simultaneous instances of file dialogs for a given application. These and other variations fall within the spirit and scope of the invention as set forth in the appended claims. Embodiments of the invention also include a computer-readable medium having instructions recorded thereon which, when executed by a processor, perform steps of a method and/or that implement a software architecture. As used in the claims, the phrase “data indicative of” includes pointers or other references to data located elsewhere, as well as the actual data itself. In the claims, various portions are prefaced with letter or number references for convenience. However, use of such references does not imply a temporal relationship not otherwise required by the language of the claims.

1. A method of creating a dialog user interface, comprising:
(a) receiving from a first computer program a request to generate a file dialog graphical user interface, wherein
(i) the file dialog has a format defined by a second computer program,
(ii) the format defines a graphical display area for the file dialog, the defined area having plural regions, one of the plural regions being an extensibility region having a predefined position relative to one or more other of the plural regions,
(iii) the format includes a predefined collection of user interface (UI) control types, each UI control type of the collection being capable of receiving user input,
(iv) the format permits inclusion in the extensibility region of multiple UI controls of one or more types selected from the collection, and
(v) the request identifies at least one UI control of a type in the collection; and
(b) generating the requested file dialog in the second program, in response to the request of step (a) and according to the format, so as to include the at least one identified UI control in an extensibility region of the generated dialog.

2. The method of claim 1, wherein the plural regions further include:
(i) an infopane region having fields for display of information pertaining to a file being acted on by the file dialog, and
(ii) a command region having at least one UI control defined by the format.

3. The method of claim 2, wherein the plural regions defined by the format further include a browser region which can be hidden and shown by a user of the file dialog.

4. The method of claim 1, wherein step (a) comprises receiving a request from the first computer program to generate a file opening dialog for selection of a file to be opened, and wherein the format is a first format, and further comprising the steps of:
(c) receiving from the first computer program a request to generate a file saving dialog graphical user interface for input of information associated with storing a file, wherein
(i) the file saving dialog has a second format defined by the second computer program,
(ii) the second format defines a graphical display area for the file saving dialog, said defined area having plural file saving dialog regions, one of said regions being a file saving dialog extensibility region having a predefined position relative to one or more other of the file saving dialog plural regions,
(iii) the second format includes the predefined collection of user interface (UI) control types,
(iv) the second format permits inclusion in the file saving dialog extensibility region of multiple UI controls of one or more types selected from the collection, and
(v) the request identifies at least one UI control of a type in the collection; and
(d) generating the requested file saving dialog in the second program, in response to the request of step (c) and according to the second format, so as to include in an extensibility region of the generated file saving dialog the at least one UI control identified in step (c).

5. The method of claim 4, wherein:
(i) the plural regions of the display area defined by the first format include an infopane region having fields for display of information pertaining to a file;
(ii) the plural regions of the display area defined by the second format include an infopane region having fields for display of information pertaining to a file;
(iii) the first format requires placement of the file opening dialog infopane region in a first position relative to other of the plural regions of the area defined by the first format,
(iv) the second format requires placement of the file saving dialog infopane region in a second position relative to other of the plural regions of the area defined by the second format, and
(v) the first position is different from the second position.

6. The method of claim 1, wherein the predefined collection of user interface (UI) control types includes at least three UI control types from the following group: check box control, radio button control, text entry control, push button control, drop-down box control, and combo box control.

7. The method of claim 1, wherein:
(i) the request of step (a) does not include data explicitly providing a location in the requested dialog for the identified at least one UI control,
(ii) the request received in step (a) identifies multiple UI controls of one or more of the types in the predefined collection, and
(iii) step (b) comprises arranging the identified multiple UI controls based on an order in which said UI controls were identified in the request of step (a).

8. The method of claim 1, further comprising the steps of:
(c) receiving from the first computer program a second request to generate a file dialog having the format defined by the second computer program; and
(d) generating the second requested file dialog in the second program, in response to the request of step (c) and according to the format, so as not to include an extensibility region.

9. The method of claim 1, wherein:
(i) the request received in step (a) identifies multiple UI controls of multiple types in the predefined collection, and
(ii) step (b) comprises generating the requested file dialog in the second program, in response to the request of step (a) and according to the format, so as to include the identified UI controls in the extensibility region of the generated dialog.

10. A computer-readable medium having stored thereon data representing sequences of instructions which, when executed by a processor, cause the processor to perform steps of a method for creating a dialog user interface, said steps comprising:
(a) receiving from a first computer program a request to generate a file dialog graphical user interface, wherein
(i) the file dialog has a format defined by a second computer program,
(ii) the format defines a graphical display area for the file dialog, the defined area having plural regions, one of the plural regions being an extensibility region having a predefined position relative to one or more other of the plural regions,
(iii) the format includes a predefined collection of user interface (UI) control types, each UI control type of the collection being capable of receiving user input,
(iv) the format permits inclusion in the extensibility region of multiple UI controls of one or more types selected from the collection, and
(v) the request identifies at least one UI control of a type in the collection; and
(b) generating the requested file dialog in the second program, in response to the request of step (a) and according to the format, so as to include the at least one identified UI control in an extensibility region of the generated dialog.

11. The computer-readable medium of claim 10, wherein the plural regions further include:
(i) an infopane region having fields for display of information pertaining to a file being acted on by the file dialog, and
(ii) a command region having at least one UI control defined by the format.

12. The computer-readable medium of claim 11, wherein the plural regions defined by the format further include a browser region which can be hidden and shown by a user of the file dialog.

13. The computer-readable medium of claim 10, wherein step (a) comprises receiving a request from the first computer program to generate a file opening dialog for selection of a file to be opened, and wherein the format is a first format, and comprising further instructions for performing the steps of:
(c) receiving from the first computer program a request to generate a file saving dialog graphical user interface for input of information associated with storing a file, wherein
(i) the file saving dialog has a second format defined by the second computer program,
(ii) the second format defines a graphical display area for the file saving dialog, said defined area having plural file saving dialog regions, one of said regions being a file saving dialog extensibility region having a predefined position relative to one or more other of the file saving dialog plural regions,
(iii) the second format includes the predefined collection of user interface (UI) control types,
(iv) the second format permits inclusion in the file saving dialog extensibility region of multiple UI controls of one or more types selected from the collection, and
(v) the request identifies at least one UI control of a type in the collection; and
(d) generating the requested file saving dialog in the second program, in response to the request of step (c) and according to the second format, so as to include in an extensibility region of the generated file saving dialog the at least one UI control identified in step (c).

14. The computer-readable medium of claim 10, wherein:
(i) the plural regions further include a command region having at least one UI control defined by the format, and
(ii) the format permits optional inclusion in the command region of a UI control in addition to the at least one command region UI control defined by the format, and comprising further instructions for performing the steps of
(c) receiving from the first computer program a second request to generate a file dialog having the format defined by the second computer program, the second request specifying a UI control in addition to the at least one command region UI control defined by the format; and
(d) generating the second requested file dialog in the second program, in response to the request of step (c) and according to the format, so as to include the specified UI control.

15. The computer-readable medium of claim 10, wherein the predefined collection of user interface (UI) control types includes at least three UI control types from the following group: check box control, radio button control, text entry control, push button control, drop-down box control, and combo box control.

16. The computer-readable medium of claim 10, wherein:
(i) the request of step (a) does not include data explicitly providing a location in the requested dialog for the identified at least one UI control,
(ii) the request received in step (a) identifies multiple UI controls of one or more of the types in the predefined collection, and
(iii) step (b) comprises arranging the identified multiple UI controls based on an order in which said UI controls were identified in the request of step (a).

17. The computer-readable medium of claim 10, comprising further instructions for performing the steps of:
(c) receiving from the first computer program a second request to generate a file dialog having the format defined by the second computer program; and
(d) generating the second requested file dialog in the second program, in response to the request of step (c) and according to the format, so as not to include an extensibility region.

18. The computer-readable medium of claim 10, wherein:
(i) the request received in step (a) identifies multiple UI controls of multiple types in the predefined collection, and
(ii) step (b) comprises generating the requested file dialog in the second program, in response to the request of step (a) and according to the format, so as to include the identified UI controls in the extensibility region of the generated dialog.

19. A software architecture, stored on one or more computer-readable media, for creating dialog user interfaces, comprising:
(a) at least one component configured to generate on a computer display a file dialog user interface having a format defined by the at least one component, wherein the format
(i) defines a graphical display area for the file dialog, the defined area having plural regions, one of the plural regions being an extensibility region having a predefined position relative to one or more other of the plural regions,
(ii) includes a predefined collection of user interface (UI) control types, each UI control type of the collection being capable of receiving user input, and
(iii) permits inclusion in the extensibility region of multiple UI controls of one or more types selected from the collection, and
(b) at least one application program interface to access the at least one component, the at least one application program interface configured to accept data indicative of one or more UI controls of a type in the collection and to be included in a file dialog.

20. The software architecture of claim 19, wherein the format:
(i) defines the graphical display area so as to include in the plural regions an infopane region for display of information pertaining to a file being acted on by the file dialog,
(ii) defines the graphical display area so as to include in the plural regions a command region including at least one UI control, the at least one UI control in the command region also being defined by the format,
(iii) defines the graphical display area so as to include in the plural regions a browser region which can be hidden and shown by a user of the file dialog, and
(iv) includes within the predefined collection at least three UI control types from the following group: check box control, radio button control, text entry control, push button control, drop-down box control, and combo box control.
